(19) United States
(12) Patent Application Publication
(10) Pub. No.: US 2015/0374061 A1
(43) Pub. Date: Dec. 31, 2015

(54) AUTO-POWERED SAFETY EQUIPMENT

(71) Applicants: William J. HANKES, Mercer Island, WA (US); Jon T. HANLON, Mercer Island, WA (US)

(72) Inventors: William J. HANKES, Mercer Island, WA (US); Jon T. HANLON, Mercer Island, WA (US)

(73) Assignee: Onward Safety LLC, Mercer Island, WA (US)

(21) Appl. No.: 14/750,116

(22) Filed: Jun. 25, 2015

Related U.S. Application Data
(60) Provisional application No. 62/017,125, filed on Jun. 25, 2014.

(51) Int. Cl. A42B 3/04; F21V 23/04; A42B 3/08

(52) U.S. Cl. CPC A42B 3/044; A42B 3/08; F21V 23/04; F21V 23/0492; F21Y 2101/02

(57) ABSTRACT

An apparatus for detecting when a user is using safety equipment and automatically activating or deactivating powered features of the safety equipment accordingly.

### FIELD

This disclosure is directed to the field of safety equipment, and more particularly, to safety equipment that automatically determines when a user is engaged in an activity in order to activate and deactivate a related battery-powered safety feature (e.g., lights on a protective helmet).

### BACKGROUND

Some activities involve potential health hazards for which safety equipment is useful. For example, people may wear helmets while taking part in activities that involve a risk of head injuries, such as bicycling and skiing.

Bicycle riders also sometimes use lights to enhance safety during both daytime and nighttime riding. Having lights on makes the rider more visible to other riders, drivers, and pedestrians. In some places, lights are also required by law for riding at night.

The use of lights on bicycles presents some problems, however. Riders typically must remember to turn the lights on when they begin to ride, and to turn them off when they stop. A rider who forgets to turn the lights on loses the benefits of having a light, and a rider who forgets to turn the lights off will drain the lights' batteries unnecessarily.

Although some existing lighting products incorporate auto-on/auto-off functionality, these rely on constantly monitoring sensors that draw power and eventually will drain the battery, leading to the same problems present in a non-automatic light system.

### BRIEF DESCRIPTION OF THE DRAWINGS

FIG. 1 is a perspective view of an auto-powered helmet having a chinstrap in an unbuckled position in accordance with at least one embodiment.

FIG. 2 is a perspective view of the auto-powered helmet of FIG. 1 with the chinstrap in buckled position in accordance with at least one embodiment.

FIG. 3 is a partial plan view of the chinstrap of FIG. 1 in the unbuckled position in accordance with at least one embodiment.

FIG. 4 is a bottom plan view of a motion detecting auto-powered helmet having a chin-strap in an unbuckled position in accordance with at least one embodiment.

FIG. 5 is a bottom plan view of a hybrid auto-powered helmet having a chin-strap in an unbuckled position in accordance with at least one embodiment.

FIG. 6 is a control flow diagram of a logic process that may be implemented by the hybrid helmet of FIG. 5 in accordance with at least one embodiment.

FIG. 7 is a circuit diagram depicting a sensor system that may be implemented by the hybrid helmet of FIG. 5 in accordance with at least one embodiment.

### DESCRIPTION

The presently disclosed apparatus addresses these issues by detecting when a user is engaged in an activity in order to activate and deactivate related battery-powered safety equipment. Exemplary embodiments are shown as bicycle helmets that use switches and/or sensors of various types to detect when a user is riding a bicycle, and to automatically operate safety lights accordingly. In these embodiments, the safety lights are automatically activated when the user is using the helmet and deactivated when the user is not using the helmet. When each helmet is not in use, it reverts to a state that draws very little or no power from the battery.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to or combined without limiting the scope to the embodiments disclosed herein.

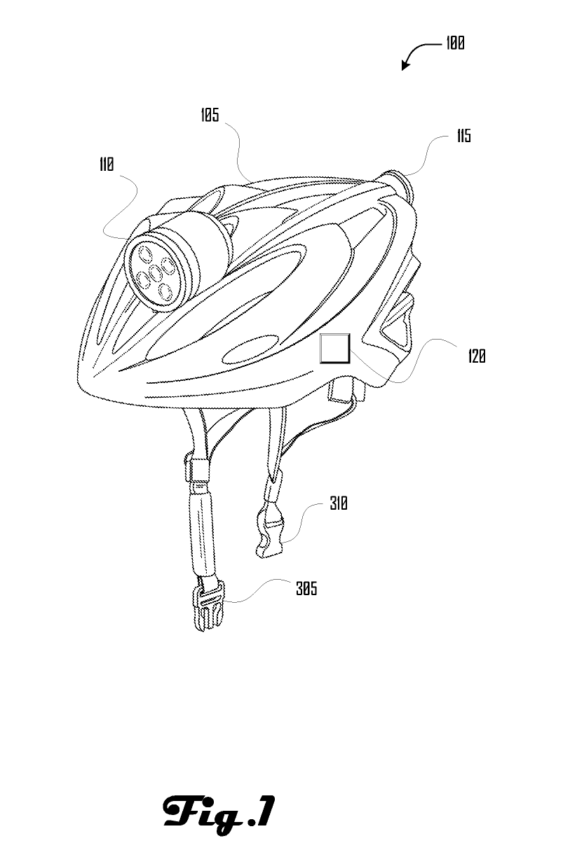

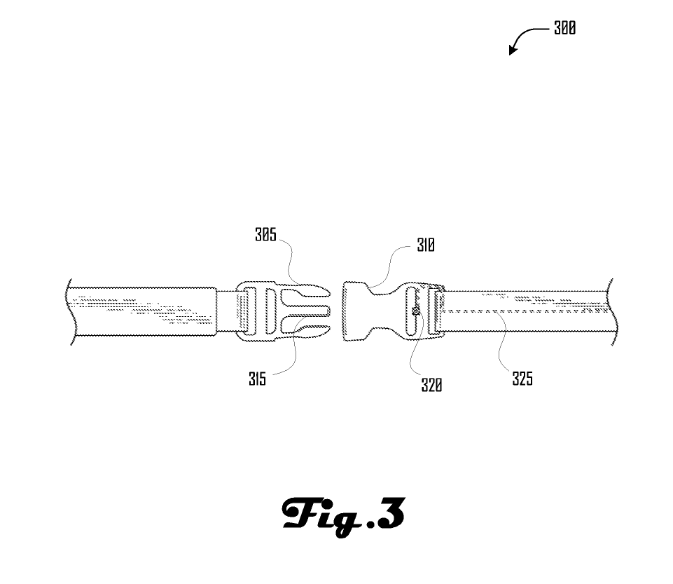

FIG. 1 depicts an example helmet (“buckle helmet”) 100. Buckle helmet 100 is a bicycle helmet that includes, among other components, a shell 105, a front safety light 110, a rear safety light 115, a battery 120, and a chin strap 300 with male buckle 305 and female buckle 310. Female buckle 310 contains a switch 320 that is connected to circuit 325. (See FIG. 3.)

In FIG. 1, buckle helmet 100 is configured with buckles 305 and 310 uncoupled. So configured, lights 110 and 115 are inactive. When the user puts on the helmet, he fastens the chin strap in the normal manner by coupling buckles 305 and 310 together. When male buckle 305 is fully inserted into female buckle 310, tongue 315 of buckle 305 depresses switch 320, closing circuit 325. (See FIG. 3.) When circuit 325 is closed, lights 110 and 115 are activated without requiring any further action by the user.

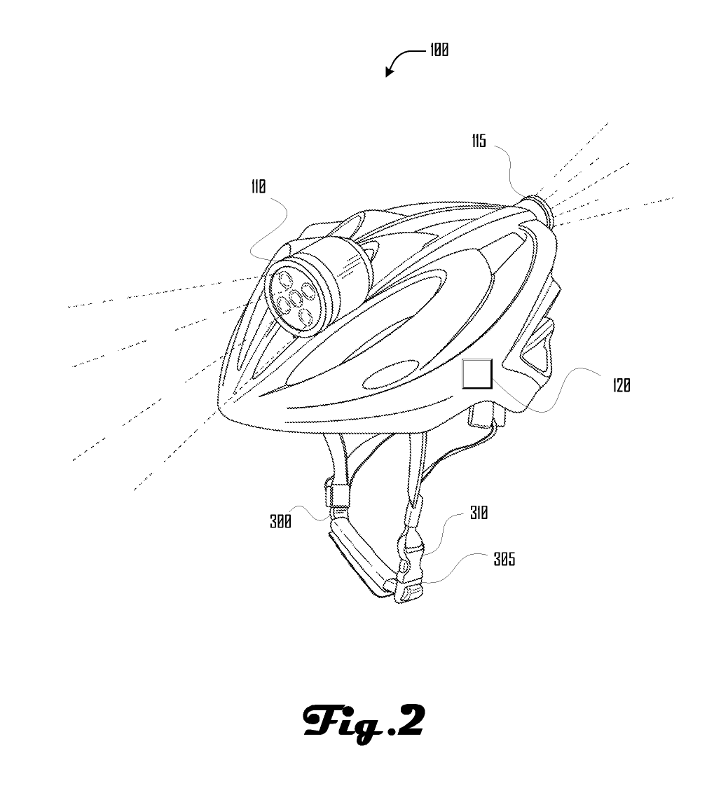

FIG. 2 shows buckle helmet 100 configured with chin strap 300 fastened and lights 110 and 115 active.

FIG. 3 shows a detailed view of chin strap 300, as used in buckle helmet 100. As described above, female buckle 310 contains a switch 320. Switch 320 in turn is connected to circuit 325. Circuit 325 connects lights 110 and 115 to battery 120. When the user fastens chin strap 300, tongue 315 of buckle 305 depresses switch 320. Depressing switch 320 closes circuit 325, which activates safety lights 110 and 115. When the user uncouples buckles 305 and 310, tongue 315 no longer depresses switch 320, and circuit 325 opens. Safety lights 110 and 115 turn off accordingly. Thus, when the user finishes using the helmet and takes it off, the lights automatically turn off.

In buckle helmet 100, safety lights 110 and 115 are LED lights, which offer brighter illumination and lower power consumption than other types of currently available consumer lighting technology. When active, light 110 emits a steady beam of white light and light 115 emits a steady beam of red light, mimicking the configuration of a car's headlights and taillights. Light 110 enhances safety both by illuminating the path ahead to aid the user's vision, and by making the user more visible to traffic and pedestrians. Light 115 primarily enhances safety by making the user more visible to traffic approaching from the rear.

Lights 110 and 115 are attached permanently to buckle helmet 100. The attachment mechanism and placement are such that the lights do not affect the structural integrity or crashworthiness of buckle helmet 100. Similarly, battery 120 is embedded within buckle helmet 100 in a location that does not affect the structural integrity or crashworthiness of the helmet and allows for a reasonable degree of user comfort.

Buckle helmet 100 thus provides the advantages of safety lights without requiring the user to remember to turn the lights on when he begins riding or to turn the lights off when he stops riding. This may be particularly helpful for use on helmets designed for children, who are less likely to remember to use lights that require manual operation, e.g. by toggling a dedicated switch. Similarly, children are more likely to forget to manually turn off lights at the end of a ride, leading to unnecessary battery drain unless the lights turn off automatically. By relying on chin strap 300 to control the lights, buckle helmet 100 solves both of these common problems.

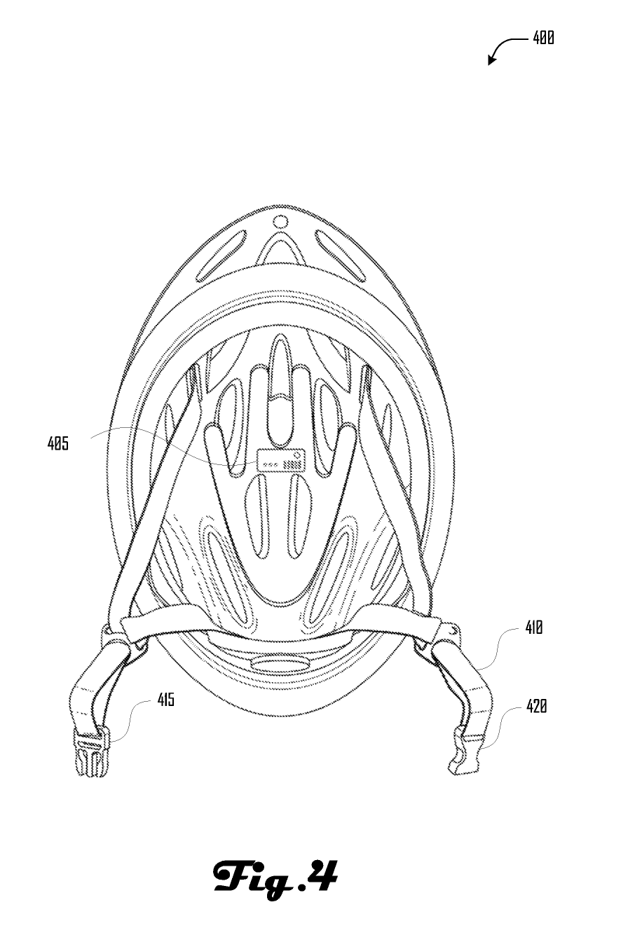

In some embodiments, a mechanism other than the chin strap may be used to detect whether a user is currently using a helmet. FIG. 4 depicts such an alternative embodiment (“motion-sensing helmet”) 400. Motion-sensing helmet 400 uses an ordinary chin strap 410 instead of chin strap 300. Thus, unlike buckle helmet 100, motion-sensing helmet 400 cannot rely on the coupling of chin-strap buckles 415 and 420 to determine when a user is using motion-sensing helmet 400.

Instead, motion-sensing helmet 400 includes a motion sensor such as an accelerometer 405. Accelerometer 405 is a low-power accelerometer, such as the ADXL362 sold by Analog Devices of Norwood, Mass., the LIS3DH sold by STMicroelectronics of Geneva, Switzerland, or the like. When accelerometer 405 detects motion, it activates safety lights (similar to safety lights 110 and 115, not shown) on motion-sensing helmet 400. When accelerometer 405 no longer senses motion, it deactivates the safety lights. Accelerometer 405 is located within motion-sensing helmet 400 such that it can reliably detect motion of the helmet but does not interfere with the user's comfort or ordinary use of the helmet. Accelerometer 405 is also located such that it can be connected to an embedded battery and attached safety lights without affecting the structural integrity or crashworthiness of motion-sensing helmet 400.

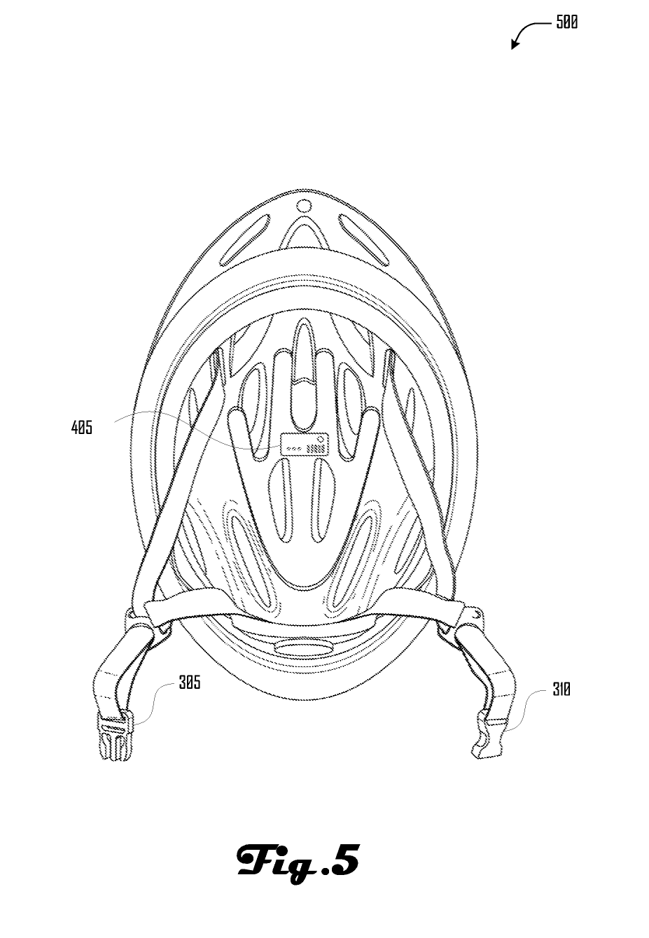

In some cases, it may be desirable to combine multiple switches and/or sensors in a single embodiment. FIG. 5 depicts such an embodiment (“hybrid helmet”) 500, which includes both chin strap 300 and accelerometer 405. By combining these components, hybrid helmet 500 is able to distinguish between certain “non-use” scenarios, when the lights should be off, and genuine use of the helmet while riding a bicycle, when the lights should be on. For example, a user may wish to store his helmet by buckling the chin strap and looping it around a handlebar of his bicycle. Using buckle helmet 100 in this way, the safety lights would remain on as long as chin strap 300 were buckled, leading to undesirable battery drain during periods of storage. Or the user may wish to transport his helmet by car, e.g. to go on a bicycle ride far away from home. In this situation, motion-sensing helmet 400 might detect the motion of the helmet in the car and activate the safety lights, leading both to undesirable battery drain and to potentially dangerous driver distraction should the safety lights activate within his view while driving.

Unlike buckle helmet 100 and motion-sensing helmet 400, hybrid helmet 500 is able to produce the desired results (i.e., safety lights deactivated) in both of the above scenarios. Yet hybrid helmet 500 is still able to automatically activate the safety lights when the user puts on the helmet to start riding, and to automatically deactivate the lights when the user stops riding and takes the helmet off. This is possible because hybrid helmet 500 is configured to activate the lights only when both chin strap 300 is buckled and accelerometer 405 indicates that the helmet is moving.

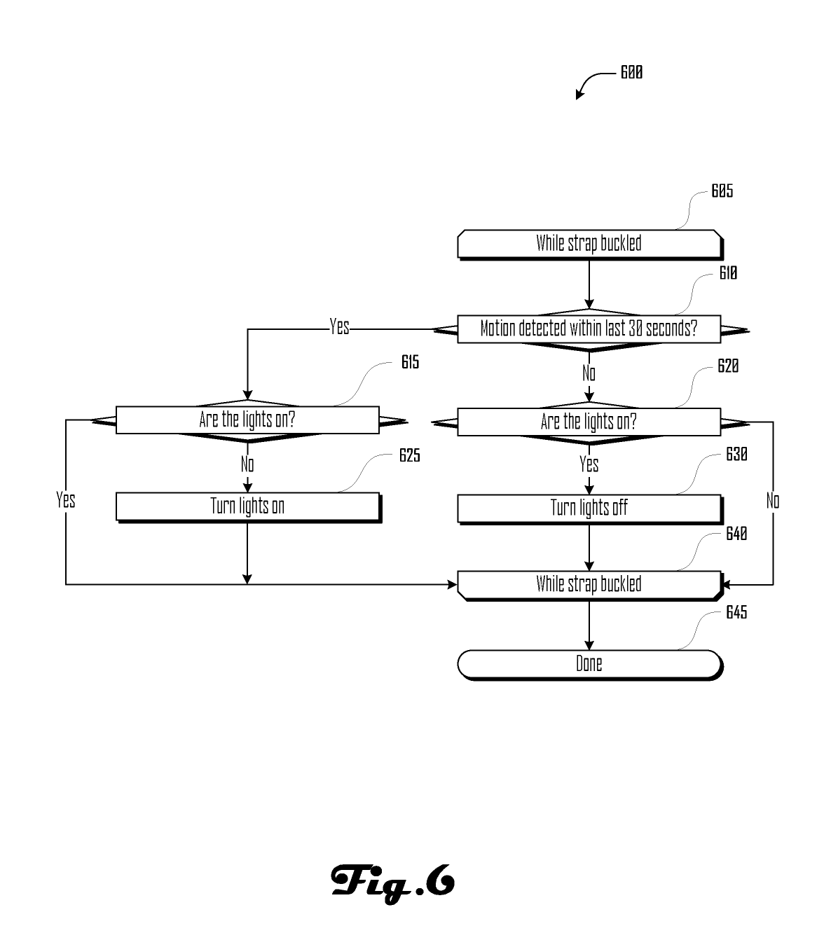

Process flow 600 (FIG. 6) shows the logic implemented in hybrid helmet 500 to determine when to activate and deactivate the safety lights. When buckles 305 and 310 are connected (i.e., when chin strap 300 is fastened) in block 605, circuit 325 closes, providing power to accelerometer 405. If accelerometer 405 detects motion at block 610 and the lights are not already on, a signal is generated at block 625 to turn on the lights. Thus, when a user fastens the chin strap and then moves (as will ordinarily be the case when he puts on the helmet in order to ride a bicycle) the lights will turn on automatically. If the chin strap is fastened but the accelerometer does not detect movement, however, the lights will remain off. Thus, even if the user stores hybrid helmet 500 with the chin strap buckled, the lights will remain off while the helmet is not moving, as during periods of storage. Similarly, if the chin strap is not buckled, accelerometer 405 will not receive power and cannot activate the safety lights even if hybrid helmet 500 is moving, as would be the case if hybrid helmet 500 were being transported by car. The safety lights, battery, and placement of the accelerometer are the same in hybrid helmet 500 as in motion-sensing helmet 400, described above.

During the user's ride, hybrid helmet 500 may not be moving continuously. For example, if the user stops for a traffic signal and holds his head still, chin strap 300 will still be fastened but accelerometer 405 will no longer detect movement. In such a situation, it may be desirable to delay turning off the safety lights until the helmet has remained still for a sufficient period of time to indicate that the user is no longer using the helmet. Hybrid helmet 500 implements such a feature in block 610, where the process flow accounts for movement that may have occurred within a certain period of time. In block 610, this period is 30 seconds, but in other embodiments, this period could be another value or could be user-configurable. Once the lights are first activated in block 625, they will remain on until accelerometer 405 has failed to detect motion for the specified length of time. If the specified period passes without accelerometer 405 detecting movement, the safety lights will turn off as shown in blocks 620 and 630, even if chin strap 300 remains buckled. The monitoring process continues as long as chin strap 300 remains fastened, as indicated in block 640. If accelerometer 405 detects motion at any time while chin strap 300 is still fastened, as in block 610, the lights are turned on, as shown in blocks 615 and 625.

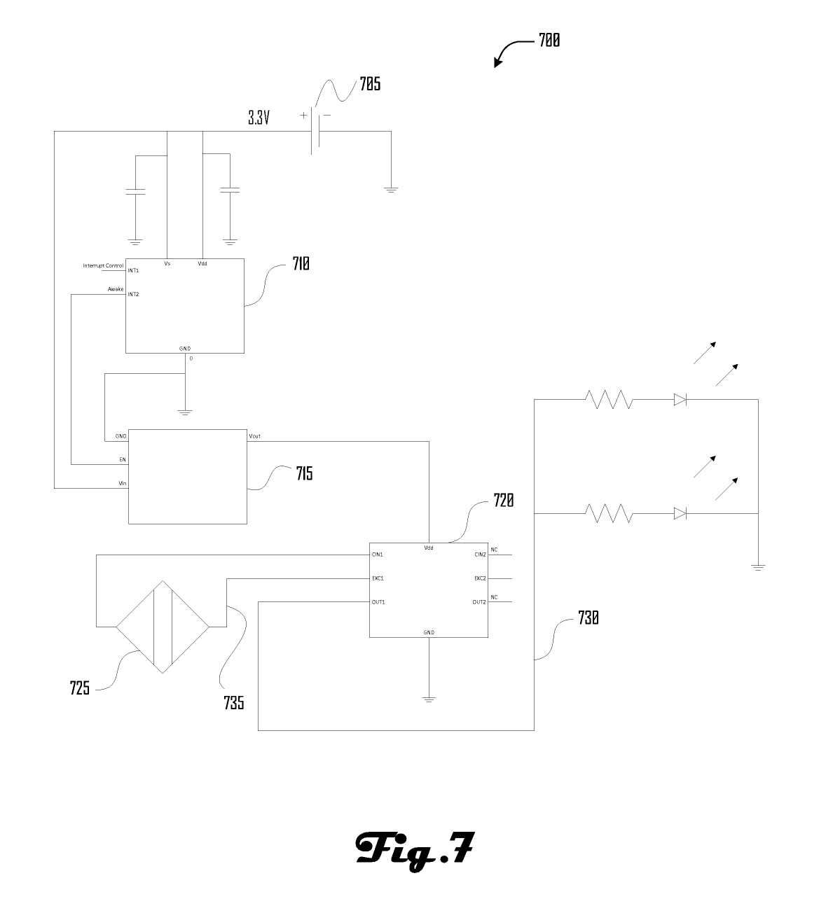

Still other embodiments could use other types of switches and/or sensors. For example, FIG. 7 depicts a circuit diagram 700 for a helmet embodiment that includes an accelerometer 710 and a capacitive proximity sensor 725. Battery 705 is connected to accelerometer 710. Similar to accelerometer 405, accelerometer 710 may be a low-power sensor such as the ADXL362, LIS3DH, or the like. When accelerometer 710 detects movement, it activates switch 715, providing power to signal processor 720. When the user places the helmet on his head, proximity sensor 725 detects a shift in capacitance and closes circuit 735. When signal processor 720 is receiving power from switch 715 (indicating that accelerometer 710 detects movement) and circuit 735 is closed (indicating that an object, presumably the user's head, is occupying the helmet), signal processor 720 energizes output wire 730, thus providing power to safety lights such as lights 110 and 115 (not shown).

Many variations of the details disclosed above are possible in other embodiments without departing from the scope of the present disclosure. Possible variations include, without limitation:

### Types of Sensors and/or Switches

Sensors and/or switches other than those described above (i.e., accelerometers 405 and 710, sensor 725, and switch 320) could be used. For example, some embodiments could use an external light sensor to sense ambient light levels, or an internal light sensor to sense when the user has placed his head inside the helmet. Other sensors, such as infrared motion detectors or pressure sensors, could also be used. Any switch, sensor, or combination of switches and sensors that is capable of informing the operation logic about whether an embodiment is currently being used could be included, subject to ordinary operational constraints such as power draw, weight, and packaging and placement options.

### Sensor and/or Switch Placement

The sensors and/or switches used may be placed anywhere that allows them to operate as intended while preserving the basic functionality of a bicycle helmet, such as reasonable degrees of safety and user comfort. For example, if an embodiment employs a pressure sensor intended to detect the insertion of a user's head into the helmet, the sensor would need to be located on the underside of the helmet in a spot where the user's head would reliably trigger the sensor during use. If the sensor in question is an accelerometer, however, it could be located under the helmet (as with accelerometer 405), or it could be located on the exterior shell, within the foam substrate, or at any other location that allows it to sense motion and control the operation of the lights accordingly.

### Power-Source Technology, Size, Capacity, and Location

The scope of the present disclosure does not depend on the use of any particular power-source technology, size, capacity, or location. Current technologies such as lithium polymer batteries provide potentially desirable characteristics such as small size, light weight, high capacity, recharging ability, customizable shapes, durability, and low self-discharge rates. It is anticipated, however, that future power-source technologies may improve upon the current state of the art in these or other areas (e.g., cost). Any such power source that is capable of powering the safety equipment and related sensors could be incorporated into future embodiments without departing from the scope of the present disclosure. Additionally, some of the above-listed characteristics may prove undesirable in some embodiments (e.g., consumers may prefer to use disposable, rather than rechargeable, batteries), and thus are not intended to limit the scope of the present disclosure in any way.

### Lighting Technology

As with power-source technology, lighting technology may advance in the future. While the specific embodiments described in the present disclosure utilize LED lights, the scope of the disclosure is not intended to be so limited. Any light or lights that a user might wish to have automatically illuminated while he is riding and automatically deactivated while he is not could serve the same role as the LED safety lights described in the illustrative embodiments.

Furthermore, the lights used in a particular embodiment may be capable of more than basic on/off behavior. For example, flashing lights may enhance visibility compared to steady beams, especially during the daytime, and flashing could be the default mode of operation in some embodiments. Or, in an embodiment with a rear-facing light and an accelerometer, it may be desirable for the rear light to operate similar to an automotive brake light, activating (or switching to a distinctive mode, such as flashing) whenever the user slows down, in order to warn those behind. The present disclosure is intended to encompass all such possible embodiments.

### Light Placement and Construction

Other embodiments may include different configurations of safety lights. For example, front- and rear-facing lights could be integrated within the profile of the helmet instead of attached as distinct components as depicted in buckle helmet 100. Other lights could also be used in addition to or instead of large front and rear lights. For example, a ring of small LED lights running around the base of the helmet could make a rider more visible, and thus might be desirable as a safety feature that could be automatically activated and deactivated as described above.

In some embodiments, safety lights could also be detachable from the helmet. Placing lights on the helmet has certain advantages, such as always providing light in the direction the user is looking, and in the case of children, locating lights as high as possible to improve visibility for drivers. Placing lights elsewhere may also have benefits, however. For example, a user may wish for the lights always to point in the direction of travel rather than the direction of his gaze, which could be accomplished by attaching lights to the handlebars instead of to the helmet. Detaching the lights from the helmet could also make the helmet lighter, less expensive, and/or more upgradable, while also allowing for a wider variety of light configurations and easier upgrades to the lights themselves. Such an embodiment may also have the ability to activate and deactivate the lights wirelessly, and/or to interface with lights that may be embedded within the bicycle by the bicycle manufacturer. Although the embodiments described herein contain lights that are attached to the helmet, the present disclosure is intended to include potential embodiments with other configurations of lights as well.

Still other embodiments may not include lights at all. A helmet with an accelerometer and cell-phone interface, but no lights, could still provide significant safety benefits, e.g. by automatically dialing emergency services upon detecting a crash, as described below. Or some embodiments could include, e.g., speakers capable of providing information to the user or others via audio signals, or devices capable of communicating with in-dash or smartphone apps in automobiles to warn drivers that a cyclist using the technology is nearby. The present disclosure is intended to include all such potential embodiments, and is not limited to devices that utilize lights.

### Other Equipment

Some helmet-type embodiments may contain equipment that, although not described herein, would also benefit from the auto-on/auto-off functionality presently disclosed. For example, cell-phone connectivity could be used to add capabilities to some embodiments. In one potential embodiment, this could be accomplished via a wireless protocol such as Bluetooth. Using various sensors and switches as described above, the helmet could detect when it is in use. Upon detecting use, the helmet would power up the Bluetooth interface and connect to the phone, instead of or in addition to activating safety lights as described above.

Using such wireless connectivity, such an embodiment could implement additional safety-related and/or non-safety-related features. For example, one potential embodiment might comprise a helmet with an accelerometer. The helmet could be configured to monitor for signs that the user may have crashed, such as a sudden, large-magnitude acceleration event. Upon observing such an event, the helmet could use the connected phone to automatically dial emergency responders and transmit a message indicating that the user may need assistance.

The user could also use a smartphone app with such an embodiment to interact with the devices present in the helmet. For example, the smartphone app could allow the user to check the remaining capacity of the battery used to power the lights and sensors. If the embodiment included an external light sensor, the user could use the smartphone app to switch between a “normal” mode, where the lights are active whenever the user is using the helmet, and a “night-only” mode, where the lights are active only when the user is using the helmet and external light levels are below a threshold value, in order to conserve battery life during daytime use. The smartphone app could also be used to manually turn the lights on or off, to alter the logic used to determine what configuration of the available sensors and/or switches most accurately indicates that the helmet is currently in use, or to interact with the helmet and its sensors in other ways. The present disclosure is intended to include all such potential embodiments.

### Non-Helmets

The present disclosure is not limited to helmet-type embodiments or to the sport of bicycle riding. Rather, various embodiments may prove useful for any activity that involves powered equipment where it is possible to automatically detect when a user is participating in the activity, and thus to provide efficient auto-on/auto-off functionality. Some examples of such activities include road construction, airport ramp, and railroad operations, where workers rely on safety equipment to enhance their visibility and ensure their safety.

A person of ordinary skill in the art will appreciate that many other combinations of sensors, switches, and operation logic could be implemented without departing from the scope of the present disclosure. The disclosure is intended to encompass all such potential embodiments.

We claim:

1. A bicycle helmet as shown and described herein.
